(19) United States
(12) Patent Application Publication
(10) Pub. No.: US 2021/0308647 A1
(43) Pub. Date: Oct. 7, 2021

(54) POLYIMIDE AEROGEL HAVING CONTROLLED PARTICLE SIZE AND PORE STRUCTURE, AND METHOD FOR PRODUCING SAME

(71) Applicant: KOREA ELECTROTECHNOLOGY RESEARCH INSTITUTE, Changwon-si (KR)

(72) Inventors: Dae Ho LEE, Changwon-si (KR); Moon Jung JO, Changwon-si (KR); Hyo Yul PARK, Changwon-si (KR); Seung Gun YU, Paju-si (KR); Se Won HAN, Changwon-si (KR)

(73) Assignee: KOREA ELECTROTECHNOLOGY RESEARCH INSTITUTE

(21) Appl. No.: 17/238,426

(22) Filed: Apr. 23, 2021

Related U.S. Application Data
(63) Continuation of application No. PCT/KR2019/014108, filed on Oct. 25, 2019.

(30) Foreign Application Priority Data
Oct. 26, 2018 (KR) 10-2018-0128614
Oct. 21, 2019 (KR) 10-2019-0130977

(51) Int. Cl. B01J 13/00; C08G 73/10; C08L 33/24

(52) U.S. Cl. CPC B01J 13/0091; C08G 2101/00; C08L 33/24; C08G 73/1032

(57) ABSTRACT

Proposed are a polyimide aerogel having a controlled particle size and pore structure, and a method for producing the same. More particularly, proposed are a polyimide aerogel in which not only can the particle size of a polyimide resin be controlled, but the pore structure of the polyimide aerogel can also be controlled through an organic solvent mixture, and a method for producing the polyimide aerogel. This can be achieved through: a first step of preparing a solvent; a second step of synthesizing a polyamic acid resin by reacting a diamine-based monomer and an acid anhydride monomer in the solvent; a third step of forming a polyimide resin through imidization of the polyamic acid resin by subjecting the polyamic acid resin to a high-temperature reaction at 150 to 200° C.; a fourth step of forming a polyimide wet-gel by crosslinking the polyimide resin; and a fifth step of forming a polyimide aerogel by replacing the solvent included in the polyimide wet-gel with a solvent having a relatively lower boiling point than the solvent included in the polyimide wet-gel and then removing the solvent.

### REFERENCE TO RELATED APPLICATIONS

This is a continuation of pending International Patent Application PCT/KR2019/014108 filed on Oct. 25, 2019, which designates the United States and claims priority of Korean Patent Application No. 10-2018-0128614 filed on Oct. 26, 2018, and Korean Patent Application No. 10-2019-0130977 filed on Oct. 21, 2019, the entire contents of which are incorporated herein by reference.

### FIELD OF THE INVENTION

The present disclosure relates generally to a polyimide aerogel having a controlled particle size and pore structure, and a method for producing the same. More particularly, the present disclosure relates to a polyimide aerogel in which not only can the particle size of a polyimide resin be controlled, but the pore structure of the polyimide aerogel can also be controlled through an organic solvent mixture, and to a method for producing the polyimide aerogel.

### BACKGROUND OF THE INVENTION

In general, with their highest level of heat resistance, strength, and insulation performance among organic polymers, polyimides are used in various industrial fields such as automobiles, aircrafts, ships, electronic devices, displays, and semiconductors.

Most of these polyimides have been applied in the form of films, and research on a form having porosity or a form having an aerogel structure with super porosity has been in the spotlight.

In particular, polyimide is used as a substrate and an insulating layer for a flexible printed circuit board (FPCB) and an integrated circuit. In recent years, in order to suppress signal delay and loss rate due to the trend toward high performance and high integration, a low dielectric constant has been required, and accordingly, research on the production of highly porous aerogels using polyimide has been actively conducted.

Of these, silica aerogel is used as a high-performance insulating material due to its advantages such as super porosity and super insulation, but is problematic in mechanical brittleness. Therefore, research to replace the silica aerogel with a product using high strength polyimide is required.

NASA and others have recently developed polyimide aerogels. For example, in “Robust, flexible and lightweight dielectric barrier discharge actuators using nanofoams/aerogels” (US 2015-0076987 A1), there has been introduced a technique in which polyamic acid as a polyimide precursor is prepared at room temperature, a wet-gel is formed, and a polyimide aerogel is produced by a supercritical drying method.

As such, aerogels are generally produced by drying a wet-gel cured in a solvent. During the drying, a supercritical drying method is mostly used, but is a high cost/high risk process because it is carried out under high-temperature and high-pressure conditions, which is problematic.

In addition, during chemical reaction of polyimide, a large amount of toxic chemicals such as pyridine are used and has to be discarded after use, which leads to environmental and harmful problems.

According to another previous research, in “Aerogel materials and methods for their production” (US 2018-0112054 A1), there has been described the production of aerogels from polymer materials such as polyimide, polyurethane, and polyurea. That is, this describes a method of applying a general ambient drying method instead of a supercritical drying method using a low surface tension solvent containing a fluorine group.

However, there is a disadvantage in terms of process time and cost in that it takes a long process time of about 5 to 10 days in a solvent replacement process before drying, and a special solvent containing a fluorine group is used.

Accordingly, there is an urgent need for research and development of a new polyimide aerogel that is controlled in its particle size and pore structure so as to be used in various fields such as low-dielectric substrate materials, insulating materials, membranes, and adsorbents.

### SUMMARY OF THE INVENTION

Accordingly, the present disclosure has been made keeping in mind the above problems occurring in the related art, and an objective of the present disclosure is to provide a polyimide aerogel in which not only can the particle size of a polyimide resin be controlled, but the pore structure of the polyimide aerogel can also be controlled through an organic solvent mixture, and to a method for producing the polyimide aerogel.

In order to accomplish the above objective, according to one aspect of the present disclosure, there is provided a method of producing a polyimide aerogel having a controlled particle size and pore structure, the method including: a first step of preparing a solvent; a second step of synthesizing a polyamic acid resin by reacting a diamine-based monomer and an acid anhydride monomer in the solvent; a third step of forming a polyimide resin through imidization of the polyamic acid resin by subjecting the polyamic acid resin to a high-temperature reaction at 150 to 200° C., a fourth step of forming a polyimide wet-gel by crosslinking the polyimide resin; and a fifth step of forming a polyimide aerogel by replacing the solvent included in the polyimide wet-gel with a solvent having a relatively lower boiling point than the solvent included in the polyimide wet-gel and then removing the solvent.

Furthermore, in the present disclosure, the fifth step may be performed by replacing the solvent included in the polyimide wet-gel with an organic solvent mixture composed of two low-boiling point solvents with a boiling point of equal to or less than 100° C., followed by drying to form the polyimide aerogel, wherein the pore structure of the polyimide aerogel is controlled by controlling a mixing amount of the two low-boiling point solvents.

Furthermore, in the present disclosure, the fifth step may be performed by forming the polyimide aerogel having a pore structure formed by a network in which nano-particles composed of polyimide, nano-walls, or a combination thereof are connected to each other in three dimensions according to a weight ratio of the two low-boiling point solvents.

Furthermore, in the present disclosure, the fifth step may be performed by carrying out solvent replacement in such a manner that a mixed solvent, which is formed by mixing a first solvent same as the solvent used in the first step and a second solvent composed of the organic solvent mixture, is added to the polyimide wet-gel, thereby replacing the solvent included in the polyimide wet-gel with the low-boiling point solvents having the boiling point of equal to or less than 100° C.

Furthermore, in the present disclosure, the mixed solvent may be added a plurality of times while gradually increasing a weight ratio of the second solvent to a weight ratio of the first solvent.

Furthermore, in the present disclosure, at least one of the two low-boiling point solvents may not undergo phase separation with the first solvent.

Furthermore, in the present disclosure, the particle size of the polyimide resin may be controlled in the third step by controlling a mixing amount of a main solvent and a sub-solvent having different solubility from the main solvent in the first step.

Furthermore, in the present disclosure, the main solvent may be selected from N-methylpyrrolidone (NMP), N,N-dimethylformamide (DMF), N,N-dimethylacetamide (DMAc), N,N-diethyl formamide, N,N-diethyl acetamide, and mixtures thereof.

Furthermore, in the present disclosure, the sub-solvent may be selected from toluene, benzene, xylene, cyclohexane, cyclohexanol, cyclohexanone, benzyl alcohol, heptanol, hexanol, ethylene glycol, dimethyl formamide, dimethyl acetamide, and mixtures thereof.

Furthermore, in the present disclosure, the particle size of the polyimide resin may be controlled in the third step by allowing at least one of the diamine-based monomer and the acid anhydride monomer to include a polar group in the second step.

Furthermore, in the present disclosure, the particle size of the polyimide resin may be controlled in the third step by subjecting particle surfaces to surface modification by adding a monoamine-based monomer selected from hexylamine, octylamine, oleylamine, octadecylamine, aminoethoxyethanol, aniline, picolylamine, ethanolamine, aminopropanol, and mixtures thereof.

According to another aspect of the present disclosure, there is provided a polyimide aerogel having a controlled particle size and pore structure, the polyimide aerogel being produced by the method.

A polyimide aerogel having a controlled particle size and pore structure and a method for producing the same according to the present disclosure for solving the above-technical problem have the following effects.

First, since a polyimide structure is synthesized by high-temperature polymerization, there is no problem of using and discarding a large amount of organic material used in imidization at room temperature.

Second, by enabling polyimide to be synthesized in various structures such as resin in solution form or resin in micro/nano-particle form, it is possible to facilitate formation of a polyimide aerogel and control of its pore structure, and to realize a porous polyimide aerogel by not only a supercritical drying method but also a general drying method.

Third, it is possible to control the particle size of a polyimide resin by controlling the polarity of solvents and monomers and modifying particle surfaces during high-temperature polymerization.

Fourth, by using an organic solvent mixture composed of two low-boiling point and low-polarity solvents during replacement of solvent in a polyimide wet-gel crosslinked from the polyimide resin, it is possible to easily control the porosity and pore structure of a finally formed polyimide aerogel.

Fifth, due to its high porosity and excellent strength, the polyimide aerogel can find application in various fields such as low-dielectric substrate materials, insulating materials, membranes, and adsorbents.

### BRIEF DESCRIPTION OF THE DRAWINGS

FIG. 1 illustrates a flowchart according to an exemplary embodiment of the present disclosure.

FIG. 2 illustrates a graph illustrating a change in particle size of a polyimide resin.

FIG. 3 illustrates a graph illustrating a change in particle size of a polyimide resin.

FIG. 4 illustrates graphs each illustrating a change in particle size of a polyimide resin.

FIG. 5 illustrates an infrared spectroscopy spectrum of a polyimide resin synthesized by high-temperature polymerization.

FIG. 6 illustrates particle SEM images of a polyimide resin.

FIG. 7 illustrates SEM images illustrating the pore structures of polyimide aerogels.

FIG. 8 illustrates graphs illustrating porosity and mechanical properties of polyimide aerogels according to Examples 3 to 8 of the present disclosure.

FIG. 9 illustrates graphs of thermogravimetric analysis of a polyimide aerogel.

FIG. 10 illustrates graphs illustrating porosity and mechanical properties of polyimide aerogels according to Examples 9 to 13 of the present disclosure.

### DETAILED DESCRIPTION OF THE INVENTION

Prior to describing the present disclosure, considering that a polyimide aerogel does not necessarily require high porosity (porosity of equal to or greater than 70%), the porosity may be varied from low to high levels depending on application purposes, a technique that controls porosity and pore structure while reducing process time and cost is very important practically.

For example, in the case of a low-dielectric substrate material using polyimide, even if its dielectric constant is equal to or less than 2, applicability is considerably increased, and this may be achieved even at a porosity level of 50 to 60%.

Therefore, the present disclosure proposes a method of producing a polyimide aerogel that has various porosities and is controlled in pore structure, in which a polyimide aerogel having a porosity ranging from low to high levels is produced by using an inexpensive industrial solvent that is easy to use, reducing solvent replacement process time, and employing a general drying method such as vacuum drying, wherein the weight ratio of two low-boiling point solvents constituting an organic solvent mixture is controlled in a solvent replacement process. In addition, the present disclosure proposes a method for controlling the particle size of polyimide resin.

Hereinafter, an exemplary embodiment of the present disclosure will be described in detail with reference to the accompanying drawings.

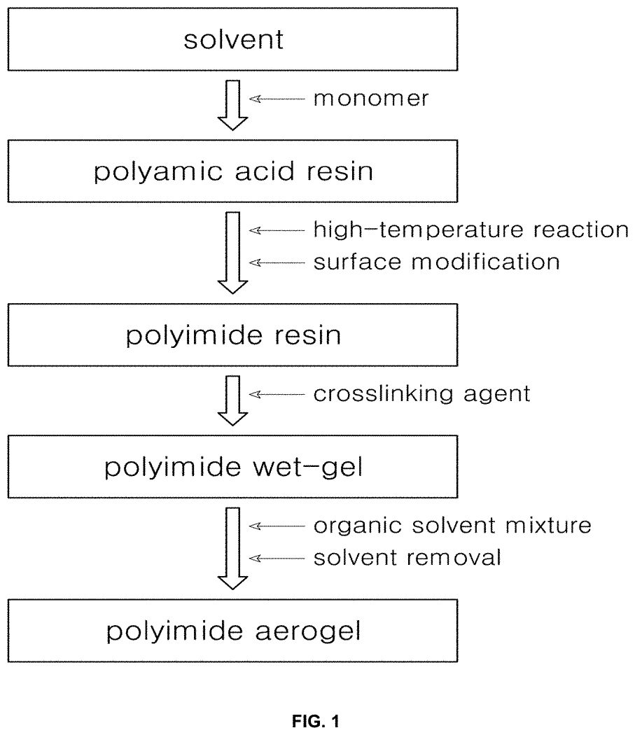

FIG. 1 is a flowchart according to an exemplary embodiment of the present disclosure. As illustrated in FIG. 1, a polyimide aerogel according to the present disclosure is synthesized through the steps including a first step (S10), a second step (S20), a third step (S30), a fourth step (S40), and a fifth step (S50). The present disclosure is characterized in that a polyimide resin may be obtained in the form of a solution or micro/nano-particles by controlling the polarity of monomers and solvents during high-temperature polymerization and modifying the surface of the particles, and a polyimide aerogel may be obtained with a controlled pore structure through crosslinking from the polyimide resin, solvent replacement using an organic solvent mixture, and solvent removal using a general drying method. Each step will be described in more detail below.

First, the first step is a step of preparing a solvent (S10).

In the first step, a solvent capable of dissolving monomers is prepared.

The solvent includes a main solvent and a sub-solvent having a different solubility from the main solvent. First, as the main solvent for polymerization reaction, any one or more of N-methylpyrrolidone (NMP), N,N-dimethylformamide (DMF), N,N-dimethylacetamide (DMAc), N,N-diethyl formamide, and N,N-diethyl acetamide are selected and used.

Subsequently, polyimide is prepared in the form of a particulate resin. To control the particle size thereof, 80 to 95 wt % of the main solvent and 5 to 20 wt % of the sub-solvent having a different solubility from the main solvent may be used in combination with each other. For example, when 80 to 95 wt % of the main solvent and 5 to 20 wt % of the sub-solvent are used in combination with each other, the particle size of the polyimide resin is optimally controlled. On the other hand, when the amount of the main solvent is less than 80 wt % or the amount of the sub-solvent exceeds 20 wt %, a diamine-based monomer and an acid anhydride monomer are not sufficiently reacted or dissolved, and when the amount of the main solvent exceeds 95 wt % or the amount of the sub-solvent is less than 5 wt %, it is impossible to expect to properly control the particle size of the polyimide resin.

For reference, as the sub-solvent, any one or more of toluene, benzene, xylene, cyclohexane, cyclohexanol, cyclohexanone, benzyl alcohol, heptanol, hexanol, ethylene glycol, dimethyl formamide, and dimethyl acetamide are selected and used, but any solvent may be used as long as it is a sub-solvent having a different solubility from the main solvent.

However, the solvent mentioned in the first step has to have a relatively higher boiling point than an organic solvent mixture to be used in the fifth step. That is, because high-temperature polymerization is carried out in the later third step, the solvent in the first step is preferably a high-boiling point solvent having a boiling point exceeding 100° C. (preferably equal to or greater than 150° C.), which does not easily volatilize at high temperature. This means that it is more preferable to select a solvent having a higher boiling point than water because water generated during the high-temperature polymerization in the third step is removed.

Next, the second step is a step of synthesizing a polyamic acid resin by reacting a diamine-based monomer and an acid anhydride monomer in the solvent (S20).

The polyamic acid resin is prepared by adding the diamine-based monomer and the acid anhydride monomer to the solvent and reacting the diamine-based monomer and the acid anhydride monomer under a nitrogen atmosphere at room temperature or low temperature (10 to 25° C.).

The diamine-based monomer is preferably selected from the group consisting of: aromatic, aliphatic, alicyclic, silicone-based diamines including any one or more of phenylene diamine, methylene diamine, 6-methyl-1,3,5-triazine-2,4-diamine, diamino bipyridyl, diaminopyrimidine, hexamethylene diamine, bis[4-(3-aminophenoxy)phenyl] sulfone, bis[4-(3-aminophenoxy)phenyl]hexafluoropropane, 1,4-bis(4-aminophenoxy)benzene, bis[4-(3-aminophenoxy)phenyl]propane, 3,5-bis(4-aminopnenoxy)benzoic acid, 4,4′-bis(4-aminophenoxy)biphenyl glycol, 4,4′-bis(4-aminophenoxy)neopentyl glycol, bis(4-aminophenyl)ether, 1,4-butanediol, bis(3-aminopropyl)ether, 1,4-cyclohexanediamine, 6,6′-diamino-2,2′-bipyridyl ammeline, 2,2′-benzidinedisulfonic acid, bis(3-amino-4-hydroxyphenyl)sulfone, bis(2-aminophenyl)sulfide, bis(3-aminophenyl)sulfide, bis(4-aminophenyl)sulfone, 2,2′-bis(trifluoromethyl)benzidine, 2,6-diaminoanthraquinone, 4,4′-diaminobenzanilide, 3,5-diaminobenzoic acid, 4,4′-diaminodiphenyl ether, 4,4′-diaminodiphenylmethane, 2,4-diamino-6-hydroxypyrimidine, 4,6-diamino-2-mercaptopyrimidine, 4,4′-diaminooctafluorobiphenyl, 1,3-diamino-2-propanol, 2,6-diaminopyridine, bis(aminopropyl)tetramethyldisiloxane, and amine-modified polydimethylsiloxane (silicone); and mixtures thereof.

For reference, because when solubility decreases as imidization proceeds during the high-temperature polymerization of the third step, excessive precipitation occurs, it is more preferable to use a monomer including a highly soluble functional group such as a carboxyl group, a sulfone group, an amide group, and an ether group among the above-described monomers.

As the acid anhydride monomer for forming an imide group, it is preferable to use a monomer including a highly soluble functional group such as a sulfone group, a carbonyl group, and an ether group in order to prevent an excessive decrease in solubility during the imidization in the solution as in the case of the diamine-based monomer.

The acid anhydride monomer is preferably selected from the group consisting of 3,3′,4,4′-benzophenonetetracarboxylic dianhydride, 4,4′-biphthalic dianhydride, 1,2,4,5-cyclohexanetetracarboxylic dianhydride, 3,3′,4,4′-diphenylsulfonetetracarboxylic dianhydride, ethylenediaminetetraacetic dianhydride, naphthalene-1,4,5,8-tetracarboxylic dianhydride, 3,4,9,10-perylenetetracarboxylic dianhydride, pyromellitic dianhydride, diethylenetriaminepentaacetic dianhydride, and mixtures thereof.

In particular, in order to prepare the polyamic acid resin with an appropriate molecular weight, it is preferable to adjust the ratio of the acid anhydride monomer (Ah) to the diamine-based monomer (Am), i.e., Ah/Am or Am/Ah to a molar ratio of 1.0 to 1.5. When the amount of either the diamine-based monomer or the acid anhydride monomer is excessive, the molecular weight decreases. When the molar ratio is less than 1.0 or exceeds 1.5, this may be disadvantageous in that an optimum molecular weight may not be obtained, as well as significantly affecting the particle size of the polyimide resin to be prepared later. Because of this, it is important to adjust the molar ratio of the acid anhydride monomer to the diamine-based monomer to 1.0 to 1.5. However, in order to prepare the polyamic acid resin with a high molecular weight, it is preferable to prepare the polyamic acid resin in a molar ratio close to 1.0.

Next, the third step is a step of forming the polyimide resin through imidization of the polyamic acid resin by subjecting the polyamic acid resin to a high-temperature reaction at 150 to 200° C. (S30).

The third step is a process of forming the polyimide resin through a high-temperature polymerization reaction or additional surface modification of the polyamic acid resin, and an amic acid structure of the polyamic acid resin completed in the second step undergoes imidization through the high-temperature reaction at 150 to 200° C., thereby completing the synthesis of the polyimide resin. For reference, it is preferable to provide auxiliary equipment (condenser, receiver, etc.) for removing water generated when the imidization occurs in the solution.

In the third step, in the case of the temperature less than 150° C., the imidization does not sufficiently occur in the amic acid structure. On the other hand, in the case of the temperature exceeding 200° C., the imidization effect does not appear more excellent compared to the case of a high-temperature polymerization reaction carried out at a temperature equal to or less than 200° C. Because of this, it is preferable to perform high-temperature polymerization in the range of 150 to 200° C.

In particular, the particle size of the polyimide resin may be controlled under three conditions, and methods thereof are as follows.

First, there is a method of controlling the particle size according to polar group control of the diamine-based monomer and the acid anhydride monomer.

That is, at least one of the diamine-based monomer and the acid anhydride monomer mentioned in the second step is allowed to include a polar group, so that imidization proceeds during the high-temperature reaction, thereby suppressing excessive micro-particle formation and precipitation due to a decrease in solubility.

In other words, by allowing at least one of the diamine-based monomer and the acid anhydride monomer to include a polar group, it is possible to suppress excessive micro-particle formation and precipitation, and control the particle size by controlling the polar group of the monomer. In addition, it is possible to prepare a resin in a solution form by using a monomer with a large polar group in equal to or greater than a predetermined amount.

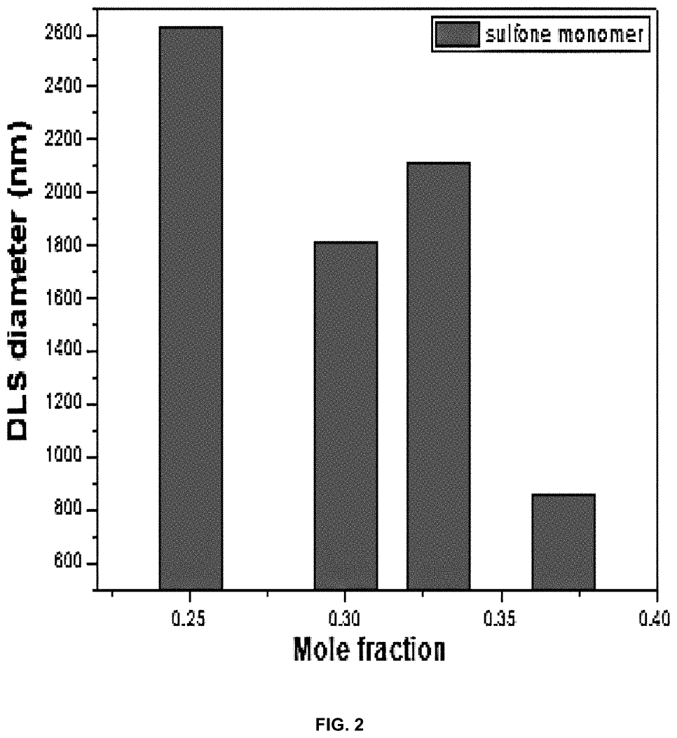

This can be confirmed by a graph of FIG. 2 illustrating a change in particle size of a polyimide resin. FIG. 2 illustrates, for example, that as the amount of a sulfone monomer, which is a polar monomer, is controlled, the amount of a polar group increases and particles become smaller. When the amount of the polar group is small, micro-particles are formed. Therefore, as illustrated in FIG. 2, the particle size decreases as the amount of the polar monomer increases, and in particular, when the molar ratio or mole fraction is equal to or greater than 0.35 to 0.4, a non-particulate resin is prepared.

Second, there is a method of controlling the particle size of the polyimide resin prepared during the high-temperature polymerization reaction by using a sub-solvent having a different solubility in addition to the main solvent mentioned in the first step.

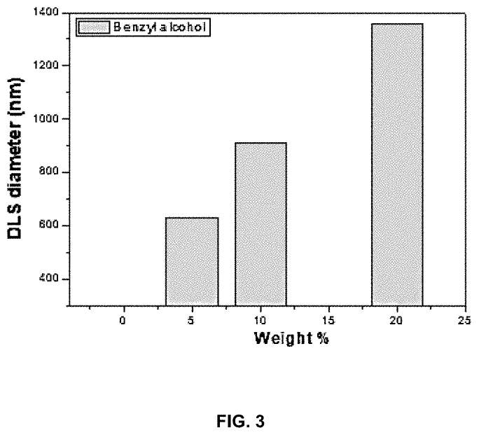

The influence of the sub-solvent on the particle size can be confirmed by a graph of FIG. 3 illustrating a change in particle size of a polyimide resin. FIG. 3 illustrates, for example, that when benzyl alcohol, which is a relatively non-polar solvent compared to N-methylpyrrolidone (NMP), is added in order to investigate the influence of the sub-solvent on the particle size of the polyimide resin, a polyimide resin in particle form is obtained, and the particle size increases according to the amount of benzyl alcohol as a sub-solvent.

Third, there is a method of controlling the particle size of the polyimide resin through particle surface treatment during the process of high-temperature polymerization.

That is, during the process in which particles begin to form at a high temperature of 150 to 200° C., particle surfaces are subjected to surface modification by adding a monoamine-based monomer selected from the group consisting of hexylamine, octylamine, oleylamine, octadecylamine, aminoethoxyethanol, aniline, picolylamine, ethanolamine, aminopropanol, and mixtures thereof.

That is, when the imidization proceeds during the high-temperature polymerization reaction, the resin begins to suspend due to particle formation. After this point, by adding a small amount of a surface treatment material such as the monoamine-based monomer, it is possible to control the particle size of the polyimide resin through particle surface modification.

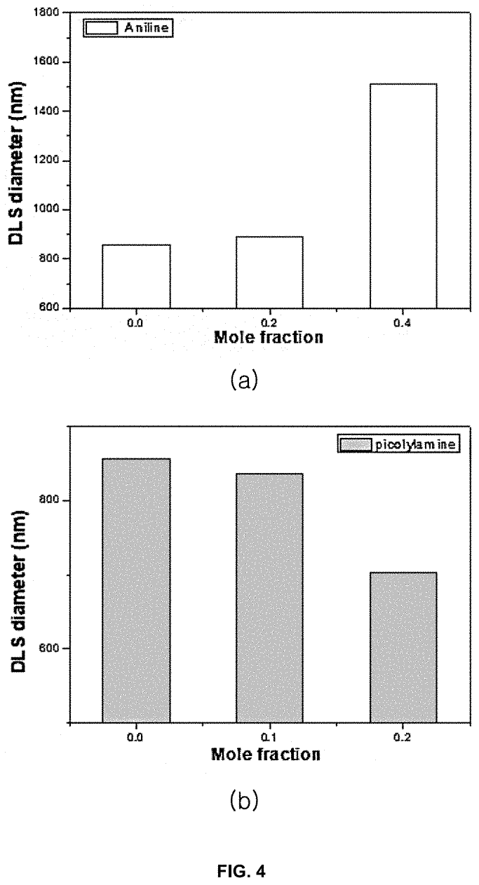

This can be confirmed by graphs of FIG. 4 illustrating a change in particle size of a polyimide resin, in which FIG. 4(a) illustrates, for example, that particle surfaces are treated with aniline so as to be almost nonpolar, and FIG. 4(b) illustrates, for example, that particle surfaces are treated with picolylamine to be almost polar. It can be confirmed by FIG. 4 that the particle size tends to increase as aniline is used, and the particle size tends to decrease as picolylamine is used.

In summary, the presence or absence of particle formation of the polyimide resin and the particle size of the resin may be controlled according to the polarity of a solvent and monomer used during high-temperature polymerization, and may also be controlled through surface treatment of particles formed during high-temperature polymerization. The polyimide resin prepared as such may be more efficiently synthesized into a highly porous polyimide aerogel later.

Next, the fourth step is a step of forming a polyimide wet-gel by crosslinking the polyimide resin (S40).

First, a crosslinking agent used in the fourth step is a material that allows the polyimide resin to crosslink to form a network. As the crosslinking agent, one or more of amine-based monomers having a trifunctional or tetrafunctional group such as melamine, triaminopyridine, tris(aminoethyl)amine, bis(hexamethylene)triamine, diethylenetriamine, trisaminophenylmethane, and pararosaniline base may be used, and inorganic nano-particles such as amine-treated silica, titania, and alumina may also be used.

In addition to the crosslinking agents described above, a trifunctional or tetrafunctional group material having an epoxy group, an isocyanate group, a hydroxy group, and an acid anhydride group that reacts with an acid anhydride group or an amine group, which is a terminal group of the polyimide resin to achieve crosslinking, may also be used. It is more preferable to use a low-temperature reactive crosslinking agent so that evaporation does not occur.

At this time, a crosslinking reaction takes place in the range of 20 to 100° C. When the crosslinking reaction is carried out at a temperature less than 20° C., it takes a lot of time to complete the polyimide wet-gel. On the other hand, when the crosslinking reaction is carried out at a temperature exceeding 100° C., this may lead to a change in physical properties, and the polyimide wet-gel cannot be obtained. More preferably, it is effective to carry out the crosslinking reaction in the range of 20 to 60° C. For reference, in the case of a high-temperature crosslinking reaction, it is necessary to pay attention to sealing in order to suppress evaporation of the solvent in order to obtain the polyimide wet-gel efficiently.

After the crosslinking agent is added as such, the polyimide wet-gel is formed in a shape suitable for a desired purpose, and may be formed into a structure through molding or prepared in a film through coating. As the polyimide resin and the crosslinking agent react as such, crosslinking is completed, thereby completing the forming of the polyimide wet-gel.

Finally, the fifth step is a step of forming a polyimide aerogel by replacing the solvent included in the polyimide wet-gel with the organic solvent mixture composed of two low-boiling point solvents with a boiling point of equal to or less than 100° C., followed by drying to form the polyimide aerogel, wherein the pore structure of the polyimide aerogel is controlled by controlling a mixing amount of the two low-boiling point solvents (S50).

First, the polyimide aerogel is preferably prepared from a resin in which the polyimide synthesized in the third step is in particle form, or a resin in which particles and non-particles are mixed, and may also be prepared from a polyimide resin in solution form rather than particle form.

In particular, conventionally, the focus was on preparing polyimide aerogels with high porosity. However, the present disclosure is characterized by controlling the porosity and pore structure of the polyimide aerogel through the fifth step as well as realizing high porosity, so that the polyimide aerogel may be appropriately adapted to a desired field of application.

That is, the polyimide aerogel in the fifth step is produced with a controlled porosity and pore structure by controlling the mixing amount of the organic solvent mixture composed of two low-boiling point and low-polarity solvents with a boiling point of equal to or less than 150° C. for solvent replacement for the polyimide wet-gel and solvent removal.

In other words, in the fifth step, there is formed the polyimide aerogel having a pore structure formed by a network in which nano-particles composed of polyimide, nano-walls, or a combination thereof are connected to each other in three dimensions according to the weight ratio of the two low-boiling point solvents constituting the organic solvent mixture.

The organic solvent mixture is composed of two selected from the group consisting of acetone, ethanol, butanol, isopropyl alcohol, hexane, cyclohexane, toluene, benzene, tetrahydrofuran, methyl ethyl ketone, methyl isobutyl ketone, chloroform, dichloromethane, ethyl acetate, and propyl acetate, which are low-boiling point and low-polarity solvents with low surface tension. However, the present disclosure is not limited to the above-described types, and other various solvents may be possible as long as they are low-boiling point and low-polarity solvents.

During the drying after replacing the polar solvent used in the first step with the organic solvent mixture composed of the two low-boiling point and low-polarity solvents, the organic solvent mixture has an effect of reducing shrinkage of pores by the action of capillary pressure, while facilitating rapid solvent removal, thus producing the polyimide aerogel with high porosity.

Regarding the boiling point of the organic solvent mixture, the boiling point may be equal to or less than 150° C., and preferably 120° C., but it is more preferable that the boiling point is equal to or less than 100° C. in order to rapidly and efficiently form the polyimide aerogel by drying immediately before drying.

A detailed process for solvent replacement in the fifth step is as follows. The solvent replacement is carried out in such a manner that a mixed solvent, which is formed by mixing a first solvent same as the solvent used in the first step and a second solvent composed of the organic solvent mixture, is added to the polyimide wet-gel, thereby replacing the solvent included in the polyimide wet-gel with the low-boiling point solvents having a boiling point of equal to or less than 100° C.

At this time, the solvent replacement is carried out by adding the mixed solvent a plurality of times equal to or greater than a predetermined number of times while gradually increasing the weight ratio of the second solvent to the weight ratio of the first solvent. It is preferable that at least one of the two low-boiling point solvents forms a homogeneous mixed solution without undergoing phase separation with the solvent of the first step and the first solvent same as the solvent of the first step, and it is more preferable that the solvent of the first step and all the solvents constituting the organic solvent mixture have mutual miscibility.

The drying is carried out after the solvent replacement is completed, and the replaced solvents have to be easy to dry. That is, the replaced solvents have the purpose of easily volatilizing and flying away, and depending on which type of solvent is used, the porosity and pore structure of the polyimide aerogel are changed.

Immediately before the drying after the addition of the mixed solvent is completed, by finally adding only a pure low-polarity solvent having a boiling point of equal to or less than 100° C., except for the first solvent that is the same as the solvent used in the first step, it is possible to achieve minimization of pore shrinkage in the process of forming the polyimide aerogel during the drying.

Controlling the porosity and pore structure of the polyimide aerogel by controlling the mixing amount according to the weight ratio of the two low-boiling point and low-polarity solvents can be confirmed as follows.

That is, when two or more solvents that are different in surface tension, polarity, and affinity and solubility with the polyimide resin are selected among the low-boiling low-polarity solvents used in the fifth step, various porosities and pore structures are generated according to the composition of the solvents constituting the organic solvent mixture.

On the other hand, in selecting the organic solvent mixture composed of the two low-boiling point and low-polarity solvents, although it is most preferable to satisfy all classifications based on the following, it is preferable to satisfy at least one condition.

First, the types of the organic solvent mixture may be classified based on surface tension. For example, the organic solvent mixture may be composed of a solvent having a surface tension of equal to or less than 25 mN/m, and a solvent having a surface tension of exceeding 25 mN/m.

Second, the types of the organic solvent mixture may be classified based on relative permittivity of the solution. For example, the organic solvent mixture may be composed of a solvent having a relative permittivity of equal to or less than 2, and a solvent having a relative permittivity of exceeding 2.

Third, the types of the organic solvent mixture may be classified based on polarity index of the solution. For example, the organic solvent mixture may be composed of a solvent having a polarity index of equal to or less than 2, and a solvent having a polarity index of exceeding 2.

In particular, as the composition of the two low-boiling point and low-polarity solvents with a boiling point of equal to or less than 100° C. is changed, there occurs a unique phenomenon in which an expected change with physicochemical values (surface tension, relative permittivity, and polarity index) is deviated. For example, the porosity of the polyimide aerogel does not simply change according to the composition ratio of solvents, but increases remarkably within a specific composition range. This will be described later through Examples 3 to 13.

Subsequently, after the solvent replacement is completed, the solvents are removed by various methods such as supercritical drying, freeze drying, vacuum drying, and ambient and high temperature drying. In order to obtain a highly porous polyimide aerogel, a supercritical drying method is most preferred, but a polyimide aerogel having a sufficient porous structure may be produced by other methods.

The drying temperature is in the range of room temperature to 200° C. In order to minimize structural destruction due to rapid solvent volatilization, it is preferable to carry out the drying at room temperature for a long period of time, or gradually increase the temperature in the case of increasing the temperature. Conventionally, there was a method of producing a polyimide aerogel with a high porosity by a general drying method instead of using the supercritical drying method. However, this was disadvantageous in process terms in that it took a long time of 5 to 10 days only for solvent replacement, and a special low-surface tension organic solvent containing a fluorine group was used. In order to solve this issue and improve productivity of the actual process, it is necessary to maximally reduce the types of the organic solvent mixture and solvent replacement and drying time in the fifth step.

Accordingly, in the present disclosure, by using the inexpensive industrial solvent, carrying out the solvent replacement within 12 hours, and carrying out the drying within 12 hours, thereby forming a final polyimide aerogel within 24 hours, which results in reducing process time and cost. The polyimide aerogel produced as such not only has high porosity, but also excellent strength, and thus can be used in various fields such as low-dielectric substrate materials, insulating materials, membranes, and adsorbents.

Hereinafter, the present disclosure will be described in more detail as follows with reference to Examples. However, the following Examples are merely illustrative to aid in understanding of the present disclosure, and the scope of the present disclosure is not limited thereby.

### Example 1

### Preparation-1 of Polyimide Resin Having Imide Group by High-Temperature Polymerization

Benzophenone-3,3′,4,4′-tetracarboxylic anhydride, 4,4′-oxydianiline, and 4, 4′-diaminophenyl sulfone were dissolved and reacted in N-methylpyrrolidone and toluene under a nitrogen atmosphere at a temperature of 25° C. to form a polyamic acid resin, and then the reaction temperature was increased to 180° C. to prepare a polyimide resin.

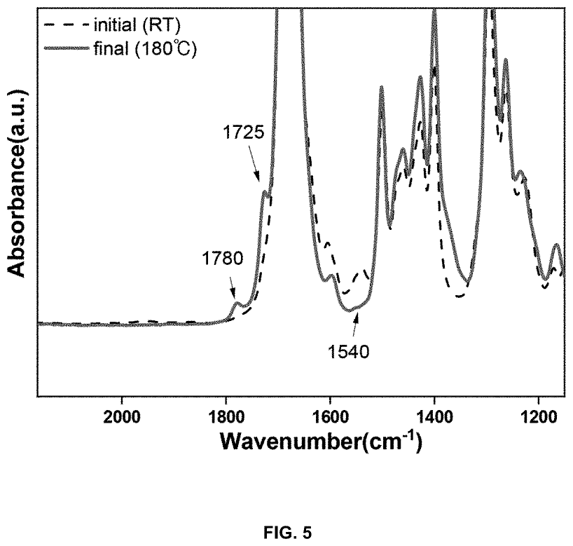

FIG. 5 illustrates an infrared spectroscopy spectrum of the polyimide resin synthesized by high-temperature polymerization. An amic acid group (1540 cm-1) is confirmed through a dotted line (before a high-temperature reaction) in FIG. 5, and an imide group (1725, 1780 cm-1) resulting from conversion of the amic acid group is confirmed through a solid line (after the high-temperature reaction) in FIG. 5. As illustrated in FIG. 5, it could be confirmed that all amic acid groups were converted to imide groups during high-temperature polymerization, and from this, it could be confirmed that the polyimide resin having an imide group was prepared.

The above-described solvents were added so that the solid amount of a final resin was 15 wt %, the above-described monomers were used such that the sum of the acid anhydride monomers relative to 1 mol of the diamine-based monomer was 1.1, particle size was changed according to the amount of diaminophenyl sulfone, which was a polar monomer, and a resin having a particle size of 2 to 3 pm was used in the following Example.

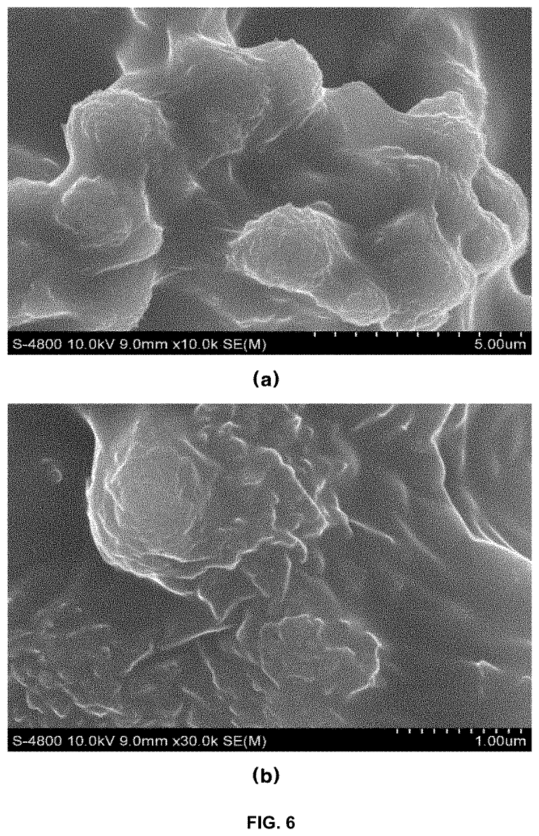

FIG. 6 illustrates particle SEM images of a polyimide resin. FIGS. 6(a) and 6(b) are enlarged SEM images of particles of the polyimide resin, and it could be confirmed that 2 to 3 pm particles of the synthesized particulate polyimide resin were composed of small particles of several tens of nanometers. In addition, a portion forming a film between particles is observed, from which it can be appreciated that a non-particulate resin in solution form also exists.

### Example 2

### Preparation-2 of Polyimide Resin Having Imide Group by High-Temperature Polymerization

The same procedure was carried out as in Example 1, except that 3,5-diaminobenzoic acid was used as a polar monomer instead of 4-aminophenyl sulfone. A prepared polyimide resin had a particle size of 2 to 3 μm, and had a structure similar to that of Example 1.

Meanwhile, polyimide aerogels were produced using the polyimide resin synthesized in Example 1, which will be described in Examples 3 to 8, and are illustrated in Table 1 below. However, among two solvents constituting an organic solvent mixture mentioned in any one or more of Examples 3 to 13 to be described later, A means ‘cyclohexane’ and B means ‘toluene’.

TABLE 1

| | Example | Example | Example | Example | Example | Example |
|---|---|---|---|---|---|---|
| | 3 | 4 | 5 | 6 | 7 | 8 |
| Polyimide | Polyimide resin of Example 1 | | | | | |
| type | | | | | | |
| Solvent | 75/25 | 50/50 | 25/75 | 100/0 | 0/100 | 0/100 |
| ratio | | | | | | |
| (A/B) | | | | | | |
| Final | A | A | A | A | A | B |
| solvent | | | | | | |
| Density | 0.550 | 0.457 | 0.560 | 0.773 | 0.698 | 0.918 |
| (g/cc) | | | | | | |
| Porosity | 63.3 | 69.5 | 62.7 | 48.5 | 53.5 | 38.8 |
| (%) | | | | | | |

### <Example 3> Production-1 of Polyimide Aerogel from Polyimide Resin of Example 1

A trifunctional amine group was added to the polyimide resin prepared in Example 1 in an amount of 5 wt % relative to the solid amount of the resin, stirred for 1 hour, and placed in a mold (20×80×2 mm) to be sufficiently crosslinked at 25° C. for 18 hours. A polyimide wet-gel prepared as such was placed in a container in which NMP and a low-boiling/low-polarity organic solvent mixture (hereinafter, referred to simply as S) were mixed, and solvent replacement was carried out.

As two organic solvents with low boiling point and low polarity, an organic solvent mixture S composed of cyclohexane A (surface tension: 24.4 mN/m, relative permittivity: 2.0, polarity index: 0.2) and toluene B (surface tension: 28.4 mN/m, relative permittivity: 2.4, polarity index: 2.4) was used, wherein the weight ratio (A/B) of cyclohexane A to toluene B=75/25.

The weight ratio of the NMP to the organic solvent mixture S was changed in stages. The NMP and organic solvent mixture S were allowed to stand for 2 hours at a weight ratio of NMP:S=75:25, 2 hours at a weight ratio of NMP:S=50:50, 2 hours at a weight ratio of NMP:S=25:75, and 2 hours at a weight ratio of NMP:S=0:100 to carry out solvent replacement, and then finally allowed to stand for 2 hours in cyclohexane B. The solvent replacement took a total of 10 hours.

Drying was then carried out in a vacuum oven at 30° C. for 2 hours, at 60° C. for 2 hours, and at 80° C. for 2 hours, followed by heat treatment at 200° C. for 3 hours to finally prepare a polyimide aerogel. The drying and heat treatment were took a total of 9 hours.

### Example 4

### Production-2 of Polyimide Aerogel from Polyimide Resin of Example 1

The same procedure was carried out as in Example 3, except that during solvent replacement, the composition of an organic solvent mixture was such that a weight ratio of cyclohexane A:toluene B=50:50.

### Example 5

### Production-3 of Polyimide Aerogel from Polyimide Resin of Example 1

The same procedure was carried out as in Example 3, except that during solvent replacement, the composition of an organic solvent mixture was such that a weight ratio of cyclohexane A:toluene B=25:75.

### Example 6

### Production-4 of Polyimide Aerogel from Polyimide Resin of Example 1

The same procedure was carried out as in Example 3, except that during solvent replacement, only cyclohexane A was used instead of an organic solvent mixture (A:B=100:0) In other words, in the case of Example 6, it can be said that two low-boiling point solvents constituting the organic solvent mixture are composed of only cyclohexane A.

### Example 7

### Production-5 of Polyimide Aerogel from Polyimide Resin of Example 1

The same procedure was carried out as in Example 3, except that during solvent replacement, only toluene B was used instead of an organic solvent mixture (A:B=0:100) In other words, in the case of Example 7, it can be said that two low-boiling point solvents constituting the organic solvent mixture are composed of only toluene B.

### Example 8

### Production-6 of Polyimide Aerogel from Polyimide Resin of Example 1

The same procedure was carried out as in Example 7, except that during solvent replacement, only toluene B was used instead of an organic solvent mixture (A:B=0:100) as in Example 6, and toluene B was also used in a final step before drying.

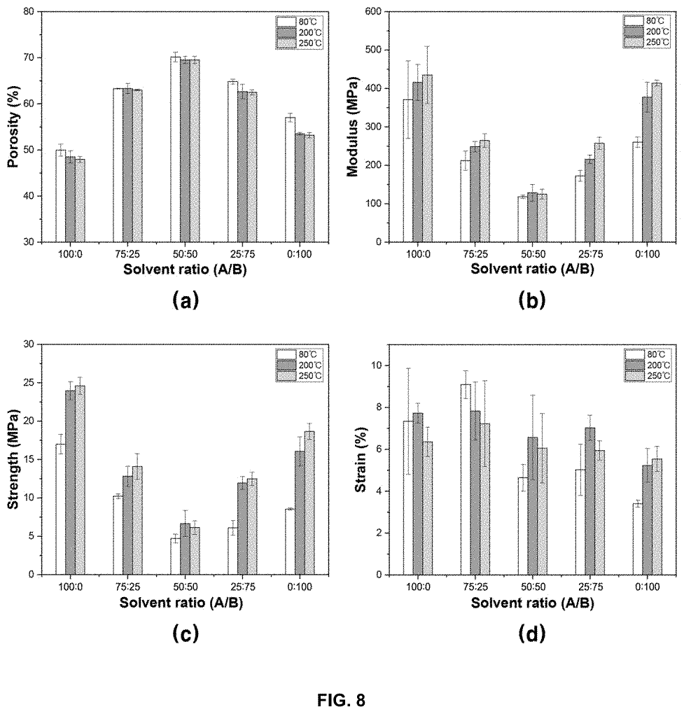

That is, as illustrated in Table 1 and FIG. 8(a), porosity was remarkably decreased as a solvent immediately before final drying was changed from cyclohexane A to toluene B compared to Example 7. Toluene has a higher boiling point, surface tension, relative permittivity, and polarity index than cyclohexane, indicating that toluene is a solvent that volatilizes during final drying and is more disadvantageous than cyclohexane.

Since, for all the Examples 3 to 7, the same drying conditions were used by unifying a final organic solvent immediately before drying as A, the change in porosity illustrated in Table 1 and FIG. 8(a) means that it has already been caused during the solvent replacement of the organic solvent mixture composed of two solvents A and B.

In more detail, this is due to formation of different pore structures depending on the solvent composition in the organic solvent mixture in a wet-gel state before drying, which will be described through SEM images below.

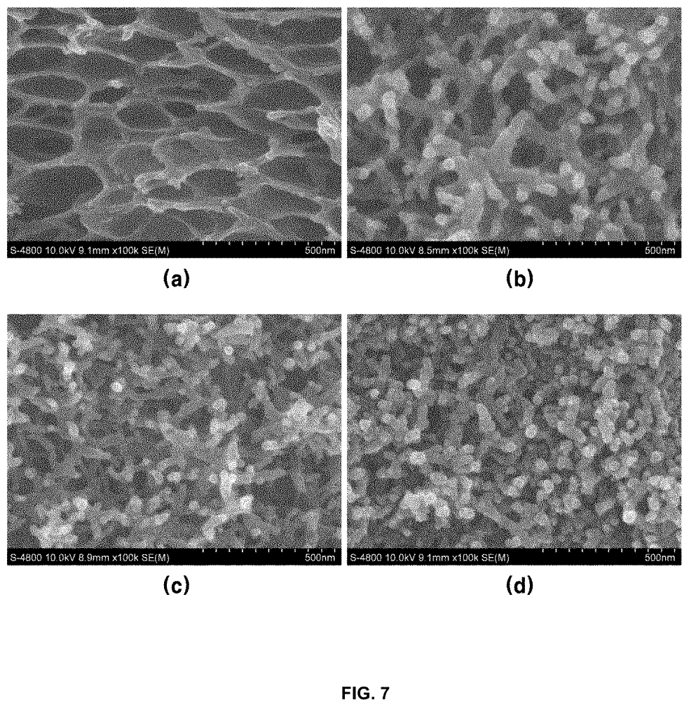

FIG. 7 illustrates SEM images illustrating the pore structures of polyimide aerogels. That is, FIG. 7 illustrates images illustrating four specimens of the polyimide aerogels produced in Examples 3 to 8 by observing the specimens with a scanning electron microscope (SEM).

FIG. 7(a) illustrates a pore structure generated by a network in which nano-walls are connected to each other in three dimensions when only cyclohexane A of Example 6 was used alone.

FIG. 7(b) illustrates a pore structure generated by a network in which nano-particles and nano-walls are connected to each other in a mixed state in three dimensions when an organic solvent mixture composed of cyclohexane A and toluene B in a weight ratio of A:B=75:25 was used.

FIG. 7(c) illustrates a pore structure generated by a network in which nano-particles and nano-walls are connected to each other in a mixed state in three dimensions, which is similar to that in FIG. 7(b), when an organic solvent mixture composed of cyclohexane A and toluene B in a weight ratio of A:B=50:50 was used.

FIG. 7(d) illustrates a pore structure generated by a network in which nano-particles of tens of nanometers are connected to each other in three dimensions when only toluene B was used alone instead of an organic solvent mixture in Example 7.

From the SEM images of the polyimide aerogels illustrated in FIGS. 7(a), 7(b), 7(c), and 7(d), it can be appreciated that, according to the weight ratio of two low-boiling point solvents, the pore structure of the polyimide aerogels is controlled to be the pore structure formed by the network in which nano-walls are connected to each other in three dimensions, the pore structure formed by the network in which nano-walls are connected to each other in three dimensions, and the pore structure formed by the network in which nano-particles and nano-walls are connected to each other in a mixed state in three dimensions.

The important point here is that, unlike the particle shape of the polyimide resin synthesized by high-temperature polymerization, which is observed in FIG. 6, particles of several micrometers or more are not well observed, and only small nano-particles of the order of tens of nanometers are mainly observed. This is because the structure of the polyimide aerogel is rearranged as a portion of a shape in which nano-particles are gathered to form micro-particles, the portion bonding the nano-particles, is dissolved through the solvent replacement of the present disclosure. As a result, a phenomenon in which a nano-sized pore structure is formed occurs.

FIG. 8 illustrates graphs illustrating porosity and mechanical properties of the polyimide aerogels according to Examples 3 to 8 of the present disclosure. First, true density was 1.50 g/cc (pycnometer measurement), and apparent density measured from weight and volume measurements of the polyimide aerogel specimens is illustrated in FIG. 8(a). Mechanical properties were measured for flexural properties in a 3-point bending mode using a universal testing machine (UTM), and graphs of the results are illustrated in FIG. 8(b), FIG. 8(c), and FIG. 8(c), which illustrate flexural modulus, flexural strength, and maximum strain, respectively.

In the case of mechanical strength, as illustrated in FIG. 8(b), the modulus is in the range of approximately 100 to 400 MPa, and as illustrated in FIG. 6(c), the strength is in the range of 5 to 20 MPa, and as illustrated in FIG. 6(d), the strain is in the range of 5 to 8%. These results show that porosity is significantly varied depending on the composition and weight ratio of the two solvents constituting the organic solvent mixture.

As the weight ratio of A to B constituting the organic solvent mixture in FIG. 8(a) goes to 100:0, 75:25, and 50:50, the modulus value in FIG. 8(b) and the strength value in FIG. 8(c) decrease. On the contrary, as the weight ratio of A to B constituting the organic solvent mixture in FIG. 8(a) goes to 50:50, 25:75, and 0:100, the modulus value in FIG. 8(b) and the strength value in FIG. 8(c) increase, and the strain value in FIG. 8(d) is not significantly varied depending on the weight ratio of A to B. These results show that the modulus and strength generally decrease with the increase in the porosity, and the strain is not significantly affected.

In addition, referring to FIGS. 8(a), 8(b), 8(c), and 8(d), each item (items 100:0, 75:25, 50:50, 25:75, and 0:100 according to the weight ratio of A to B constituting the organic solvent mixture) is represented by three bar graphs. These three bar graphs represented for each item illustrate a result of comparing the physical properties of the polyimide aerogels produced in Examples 3 to 8 after drying at 80° C., followed by drying at 200° C. for 3 hours, and additional heat treatment at 250° C. for 3 hours. From this, it can be confirmed that the polyamide aerogels remain stable as they hardly undergo pore shrinkage and decrease in physical properties according to the drying temperature.

As can be seen from these results, the porosity and pore structure are remarkably varied depending on the composition of the two solvents constituting the organic solvent mixture. In particular, it can be confirmed that the porosity is significantly increased when the organic solvent mixture composed of the two solvents A and B is used than when each of the solvents A and B constituting the organic solvent mixture is used alone.

That is, the fact that the porosity does not simply change depending on the composition of the two solvents A and B constituting the organic solvent mixture, for example, that the porosity of the polyimide aerogel increases when A and B are used in combination with each other compared to the case of using each of A and B separately, and that the porosity of the polyimide aerogel is particularly high at a weight ratio of A:B=50:50, is explained by internal nano-structures generated when the aerogel is formed. In other words, regarding the porosity, it can be confirmed that the highest porosity is exhibited when nano-particles and nano-walls exist in a properly mixed state.

Therefore, as illustrated in Examples 3 to 8, when selecting an appropriate porosity and strength according to the purpose and field of application of material, the physical properties may be easily controlled by controlling the composition of the organic solvent mixture during the solvent replacement described in the present disclosure.

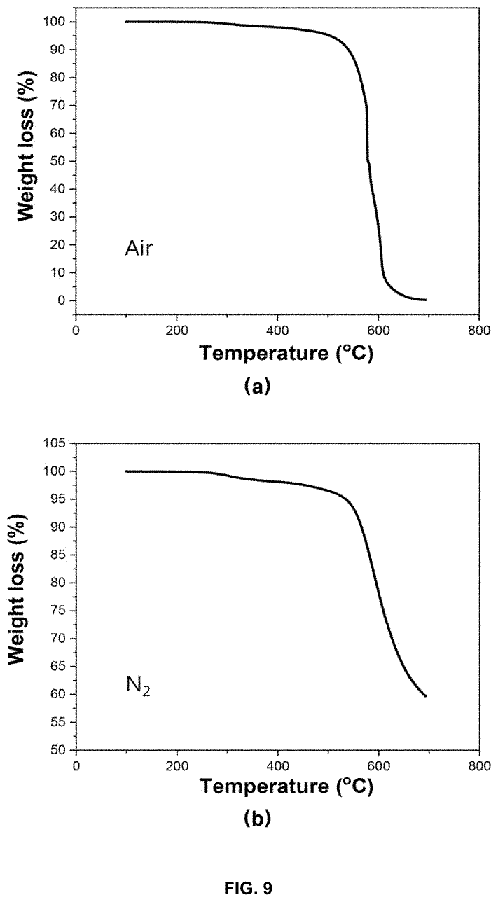

FIG. 9 illustrates graphs of thermogravimetric analysis (TGA) of a polyimide aerogel. FIG. 9(a) illustrates how much solid amount remains by burning the polyimide aerogel of Example 4 having the highest porosity while heating the same from around 100° C. to around 700° C. under an air atmosphere, and FIG. 9(b) illustrates how much solid amount remains by burning the polyimide aerogel while heating the same from around 100° C. to around 700° C. under a nitrogen atmosphere.

Referring to FIG. 9(a), the polyimide aerogel is completely burned because polyimide aerogel is oxidized and removed in the air atmosphere, with the result that a solid amount is close to a zero level at equal to or greater than 600° C. Referring to FIG. 9(b), ash in the form of carbon remains because the polyimide aerogel is carbonized in the nitrogen atmosphere, with the result that a solid amount close to 60 wt % remains at equal to or greater than 600° C.

Briefly, FIG. 9 illustrates the results of evaluating thermal stability (or heat resistance) of the polyimide aerosol of Example 4 under the air atmosphere of FIG. 9(a) or the nitrogen atmosphere of FIG. 9(b) through thermogravimetric analysis (TGA). Because the material that makes up the skeleton of the polyimide aerogel is polyimide, the temperature at which burning starts in earnest is equal to or greater than 500° C. Therefore, although burning takes place at equal to or greater than 600° C., very high thermal stability is exhibited at (equal to or greater than) 500° C. because a sufficient solid amount is secured at 500° C.

Meanwhile, polyimide aerogels were produced using the polyimide resin synthesized in Example 2, which will be described in Examples 9 to 13, and are illustrated in Table 2 below.

TABLE 2

| | Example | Example | Example | Example | Example |
|---|---|---|---|---|---|
| | 9 | 10 | 11 | 12 | 13 |
| Polyimide | Polyimide resin of Example 2 | | | | |
| type | | | | | |
| Solvent | 75/25 | 50/50 | 25/75 | 100/0 | 0/100 |
| Ratio | | | | | |
| (NB) | | | | | |
| Final solvent | A | A | A | A | A |
| Density | 0.39 | 0.33 | 0.39 | 0.74 | 0.46 |
| (g/cc) | | | | | |
| Porosity | 74.0 | 78.0 | 74.0 | 50.7 | 69.3 |
| (%) | | | | | |

### <Example 9> Production-7 of Polyimide Aerogel from Polyimide Resin of Example 2

A polyimide aerogel was produced using the polyimide resin prepared in Example 2 by carrying out the same procedure as in Example 3. However, the composition of an organic solvent mixture composed of cyclohexane A and toluene B was such that a weight ratio of cyclohexane A:toluene B=75:25.

### Example 10

### Production-8 of Polyimide Aerogel from Polyimide Resin of Example 2

The same procedure was carried out as in Example 9, except that during solvent replacement, the composition of an organic solvent mixture was such that a weight ratio of cyclohexane A:toluene B=50:50.

### Example 11

### Production-9 of Polyimide Aerogel from Polyimide Resin of Example 2

The same procedure was carried out as in Example 9, except that during solvent replacement, the composition of an organic solvent mixture was such that a weight ratio of cyclohexane A:toluene B=25:75.

### Example 12

### Production-10 of Polyimide Aerogel from Polyimide Resin of Example 2

The same procedure was carried out as in Example 9, except that during solvent replacement, only cyclohexane A was used instead of an organic solvent mixture (A:B=100:0) In other words, in the case of Example 12, it can be said that two low-boiling solvents constituting the organic solvent mixture are composed of only cyclohexane A.

### Example 13

### Production-11 of Polyimide Aerogel from Polyimide Resin of Example 2

The same procedure was carried out as in Example 9, except that during solvent replacement, only toluene B was used instead of an organic solvent mixture (A:B=0:100) In other words, in the case of Example 13, it can be said that two low-boiling point solvents constituting the organic solvent mixture are composed of only toluene B and, in a final step, is composed of cyclohexane A.

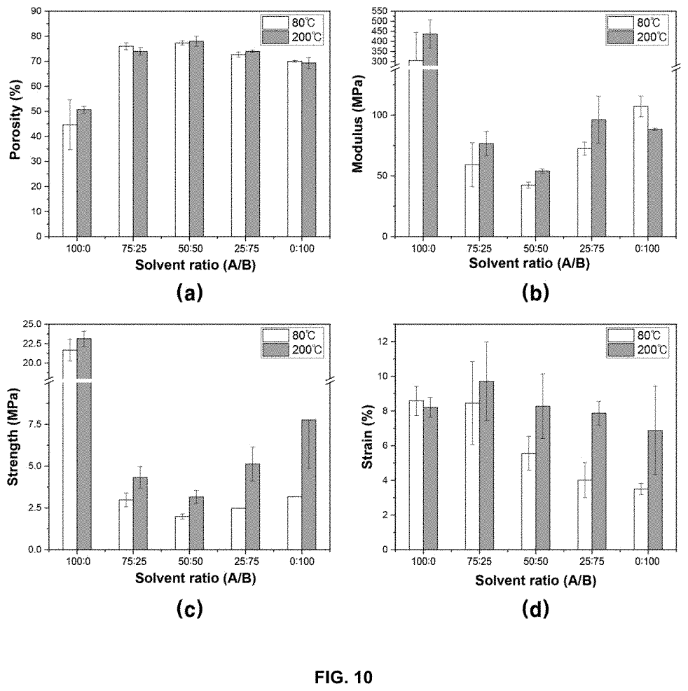

FIG. 10 illustrates graphs illustrating porosity and mechanical properties of the polyimide aerogels according to Examples 9 to 13 of the present disclosure. Density and porosity of polyimide aerogel specimens are illustrated in FIG. 10(a), mechanical properties thereof are illustrated in FIGS. 10(b), 10(c), and 10(d), illustrating flexural modulus, flexural strength, and maximum strain, respectively.

That is, FIG. 10(a) illustrates the density and porosity of the polyimide aerogel specimens prepared in Examples 9 to 13. It could be confirmed by FIG. 10(a) that most of the aerogels formed from the polyimide resin of Example 2 had a porosity of 70 to 80%, which was a higher porosity than the polyimide aerogels formed from the polyimide resin of Example 1.

Similar to Examples 3 to 8, it could be confirmed that Examples 9 to 13 had a higher porosity when using the organic solvent mixture than using a single solvent, and the porosity was varied depending on the solvent composition (see FIG. 10(a)), and the mechanical properties were significantly varied thereby (see FIGS. 10(b), 10(c), and 10(d)).

In detail, in the case where the weight ratio of A to B constituting the organic solvent mixture in FIG. 10(a) is 75:25, 50:50, 25:75, and 0:100, except for the case where the weight ratio thereof is 100:0, most of the aerogels have a porosity of 70 to 80% (however, 69.3% in Example 13). Therefore, on the contrary to the case of FIG. 10(a), the modulus value in FIG. 10(b) and the strength value in FIG. 10(c) are relatively lower in the case of the weight ratio of 75:25, 50:50, 25:75, and 0:100 than in the case of the weight ratio of 100:0, and the strain value in FIG. 10(d) is not significantly varied depending on the weight ratio of A to B. These results show that the modulus and strength tend to be generally opposite to the values of the porosity, and the strain is not significantly affected by the porosity as in Examples 3 to 8.

In addition, referring to FIGS. 10(a), 10(b), 10(c), and 10(d), each item (items 100:0, 75:25, 50:50, 25:75, and 0:100 according to the weight ratio of A to B constituting the organic solvent mixture) is represented by two bar graphs. These two bar graphs represented for each item illustrate a result of comparing the physical properties of the polyimide aerogels produced in Examples 9 to 13 after drying at 80° C., followed by drying at 200° C. for 3 hours. From this, it can be confirmed that the polyamide aerogels remain stable as they hardly undergo pore shrinkage and decrease in physical properties according to the drying temperature.

From Examples 9 to 13 described above, it can be appreciated that in the case of forming an aerogel from a polyimide resin having an imide group by a high-temperature polymerization method, the porosity of the aerogel is varied depending on the polar group type of the polyimide resin, and even in this case, it is possible to additionally control the porosity by controlling the weight ratio of two solvents of an organic solvent mixture during solvent replacement.

Therefore, by using the organic solvent mixture composed of two low-boiling point and low-polarity solvents during replacement of solvent in a polyimide wet-gel crosslinked from the polyimide resin, the present disclosure is of great significance in that the porosity and pore structure of a finally formed polyimide aerogel may be easily controlled.

The above description provides an example of the technical idea of the present disclosure for illustrative purposes only. Those skilled in the art will appreciate that various modifications, additions, and substitutions are possible, without departing from the essential features of the present disclosure.

Accordingly, the embodiments disclosed in the present disclosure are merely to not limit but describe the technical spirit of the present disclosure. Further, the scope of the technical spirit of the present disclosure is not limited by the embodiments.

The scope of the present disclosure shall be construed on the basis of the accompanying claims in such a manner that all of the technical ideas included within the scope equivalent to the claims belong to the present disclosure.

1. A method of producing a polyimide aerogel having a controlled particle size and pore structure, the method comprising:
a first step of preparing a solvent;
a second step of synthesizing a polyamic acid resin by reacting a diamine-based monomer and an acid anhydride monomer in the solvent;
a third step of forming a polyimide resin through imidization of the polyamic acid resin by subjecting the polyamic acid resin to a high-temperature reaction at 150 to 200° C.;
a fourth step of forming a polyimide wet-gel by crosslinking the polyimide resin; and
a fifth step of forming a polyimide aerogel by replacing the solvent included in the polyimide wet-gel with a solvent having a relatively lower boiling point than the solvent included in the polyimide wet-gel and then removing the solvent.

2. The method of claim 1, wherein the fifth step is performed by replacing the solvent included in the polyimide wet-gel with an organic solvent mixture composed of two low-boiling point solvents with a boiling point of equal to or less than 100° C., followed by drying to form the polyimide aerogel, wherein the pore structure of the polyimide aerogel is controlled by controlling a mixing amount of the two low-boiling point solvents.

3. The method of claim 2, wherein the fifth step is performed by forming the polyimide aerogel having a pore structure formed by a network in which nano-particles composed of polyimide, nano-walls, or a combination thereof are connected to each other in three dimensions according to a weight ratio of the two low-boiling point solvents.

4. The method of claim 2, wherein the fifth step is performed by carrying out solvent replacement in such a manner that a mixed solvent, which is formed by mixing a first solvent same as the solvent used in the first step and a second solvent composed of the organic solvent mixture, is added to the polyimide wet-gel, thereby replacing the solvent included in the polyimide wet-gel with the low-boiling point solvents having the boiling point of equal to or less than 100° C.

5. The method of claim 4, wherein the mixed solvent is added a plurality of times while gradually increasing a weight ratio of the second solvent to a weight ratio of the first solvent.

6. The method of claim 4, wherein at least one of the two low-boiling point solvents does not undergo phase separation with the first solvent.

7. The method of claim 1, wherein the particle size of the polyimide resin is controlled in the third step by controlling a mixing amount of a main solvent and a sub-solvent having different solubility from the main solvent in the first step.

8. The method of claim 7, wherein the main solvent is selected from N-methylpyrrolidone (NMP), N,N-dimethylformamide (DMF), N,N-dimethylacetamide (DMAc), N,N-diethyl formamide, N,N-diethyl acetamide, and mixtures thereof.

9. The method of claim 7, wherein the sub-solvent is selected from toluene, benzene, xylene, cyclohexane, cyclohexanol, cyclohexanone, benzyl alcohol, heptanol, hexanol, ethylene glycol, dimethyl formamide, dimethyl acetamide, and mixtures thereof.

10. The method of claim 1, wherein the particle size of the polyimide resin is controlled in the third step by allowing at least one of the diamine-based monomer and the acid anhydride monomer to include a polar group in the second step.

11. The method of claim 1, wherein the particle size of the polyimide resin is controlled in the third step by subjecting particle surfaces to surface modification by adding a monoamine-based monomer selected from hexylamine, octylamine, oleylamine, octadecylamine, a minoethoxyethanol, aniline, picolylamine, ethanolamine, aminopropanol, and mixtures thereof.

12. A polyimide aerogel having a controlled particle size and pore structure, the polyimide aerogel being produced by the method of claim 1.
